(19) United States
(12) Patent Application Publication
(10) Pub. No.: US 2024/0375737 A1
(43) Pub. Date: Nov. 14, 2024

(54) Seat Device for a Vehicle, More Particularly a Tilting Vehicle

(71) Applicant: Bayerische Motoren Werke Aktiengesellschaft, Muenchen (DE)

(72) Inventors: Christian ISING, Muenchen (DE); Dieter STRASSER, Oberhausen (DE)

(21) Appl. No.: 18/686,658

(22) PCT Filed: Sep. 23, 2022
(86) PCT No.: PCT/EP2022/076492

§ 371 Date: Feb. 26, 2024

(30) Foreign Application Priority Data
Oct. 14, 2021 (DE) 10 2021 126 615.7

(51) Int. Cl. B62J 1/10

(52) U.S. Cl. CPC B62J 1/10

(57) ABSTRACT

A seat device for a vehicle, in particular a tilting vehicle, includes at least one cushion body which forms a seat surface on a side facing a user of the vehicle; at least one transmission body which is disposed or formed on the cushion body on the side of the cushion body facing away from the seat surface and which extends away from the cushion body; at least one rigid seat shell which is disposed on a side of the cushion body facing away from the seat surface and can be fastened to a support structure of the vehicle and has at least one recess, in which at least the transmission body can be or is disposed; and at least one adjustment unit which is disposed between the cushion body and the seat shell and has at least one tensioning element. The tensioning element is disposed in the recess in the seat shell between the cushion body and the seat shell and can be transferred from a relaxed initial position, in which the depth of insertion of the transmission body into the recess in the seat shell is maximal, into at least one loaded functional position, in which the transmission body is displaced by the tensioning element into a position in which the depth of insertion of the transmission body in the recess of the seat shell is reduced in comparison with the initial position.

### BACKGROUND AND SUMMARY

The invention relates to a seat device for a vehicle, in particular a tilting vehicle.

Seat devices for vehicles, in particular tilting vehicles, in the case of which a seat must be removed to adjust the height or tilt and the height and/or the tilt of the seat are/is adjusted by relocating or reconnecting attachment geometries, are known from the prior art.

Also known are seat devices in the case of which a variable-volume interspace is arranged between a seat shell and a cushion body and this interspace can be filled with a fluid, in particular a gas or a liquid, and as a result the distance between the cushion body and the seat well can be varied. In such seat devices, it has been found to be disadvantageous that a fluid store and/or a compression means must be provided on the vehicle in order to be able to adjust a tilt or height of the seat.

An object of one exemplary embodiment of the invention is to provide a seat device for a vehicle, in particular for a tilting vehicle, for which a height or tilt adjustment is enabled in simplified fashion.

This object is achieved by a seat device for a vehicle, in particular a tilting vehicle, having at least one cushion body, which forms a seat surface on a side facing toward a user of the vehicle, having at least one transmission body, which is arranged or formed on the cushion body on that side of the cushion body facing away from the seat surface and extends away from the cushion body, having at least one substantially rigid seat shell, which is arranged on a side of the cushion body that faces away from the seat surface, is or can be directly or indirectly fixed to a carrier structure of the vehicle and comprises at least one recess in which at least the transmission body is or can be at least partially arranged, and having at least one setting unit, which is arranged between the cushion body and the seat shell and comprises at least one tensioner, which is arranged in the recess in the seat shell between the cushion body and the seat shell and can be transferred from a relaxed basic position, in which the depth of penetration of the transmission body into the recess in the seat shell is at its greatest, to at least one tensioned functional position, in which the transmission body is displaced by the tensioner into a position in which the depth of penetration of the transmission body into the recess in the seat shell is reduced with respect to the basic position.

Since the seat device comprises a setting unit which comprises at least one tensioner which makes it possible to set the depth of penetration of the transmission body, it is easy to vary the height or the tilt angle of the cushion body, in particular of the seat surface of the cushion body.

In the basic position, the depth of penetration of the transmission body into the recess in the seat shell is at its greatest. At the same time, the tensioning force made to act on the transmission body by the tensioner is at its lowest. In the functional position, the depth of penetration of the transmission body into the recess in the seat shell is reduced with respect to the basic position and the tensioning force made to act on the transmission body by the tensioner is increased with respect to the basic position.

A tilting vehicle is understood to mean motorbikes, motorcycles or motorcycle-like motor vehicles, such as motor scooters, in particular two-, three- or four-wheeled motor scooters, scooters, tiltable trikes, quadbikes or the like.

The tensioner may in principle have any desired form, provided it allows the transmission body to penetrate to the greatest extent in its relaxed basic position and displaces the transmission body out of the recess in the seat shell in a tensioned functional position. Displacing the transmission body causes the cushion body connected to the transmission body to be displaced at the same time.

In one embodiment of the seat device, it has proven to be advantageous if a free end of the tensioner is directly or indirectly fixed in or to the seat shell and/or if the setting unit comprises at least one setting means, to which an end of the tensioner that is situated opposite the free end is fixed and which makes it possible to move, in particular haul in, the tensioner for the purpose of transferring from the basic position to the functional position.

If one end of the tensioner is directly or indirectly fixed to the seat shell and the opposite end of the tensioner is stretched in or on a setting device, two support points for the tensioner are easily provided. The tensioner may be rotated by the setting device of the setting unit, for example by rotation about an axis of rotation extending through the free end. In such cases, the tensioner may comprise, for example, a rigid, rod-like or panel-like body.

In one embodiment of the seat device, it is provided that the tensioner is flexibly bendable transversely to its direction of extent and/or that the tensioner has an extensive form and comprises a blind-like or mat-like tensioner, or that the tensioner has a linear form and comprises band-like, cable-like or wire-like tensioning.

If the tensioner is flexibly bendable transversely to its direction of extent, the tensioner may be hauled in by the setting device of the setting unit.

Furthermore, in the basic position the tensioner may sag between the transmission body and the seat shell and, in such cases, act without forces with respect to the transmission body.

If the tensioner has an extensive form, a force transmitted by the tensioner to the transmission body in the tensioned functional position can be transmitted extensively. In such cases, the tensioner may be formed in the manner of a blind or a mat.

If the tensioner has a linear form and, for example, is formed in the manner of a band, cable or wire, the tensioner can have a compact design with reduced weight.

The tensioner may be flexibly bendable only transversely to its direction of extent and be inelastically, or plastically, deformable along its direction of extent.

In one embodiment of the seat device, it has proven to be advantageous if the tensioner is elastically extensible along its direction of extent and/or if the tensioner has an extensive or linear form.

This means that the tensioner additionally forms a spring assembly for the seat device. Forces from a user of the tilting vehicle, for example vibrations caused by driving the vehicle, that are transmitted to the cushion body and to the transmission body via the seat surface can be cushioned or damped by the tensioner in such cases.

The setting device of the setting unit can have a compact design if the setting device of the setting unit comprises a drum body, which can be driven in rotation and onto which the tensioner can be wound up when it is transferred from the basic position to the functional position.

In such cases, to transfer the tensioner from the basic position to the functional position, the drum body is driven in rotation in a winding-up direction, as a result of which the tensioner is wound up onto the drum body. To return the tensioner to the basic position from the tensioned functional position, the tensioner is unwound from the drum body in such cases.

Embodiments of the seat device are provided in which the tensioner bears linearly or extensively against an outer surface of the transmission body at least in the functional position or the tensioner is at least partially arranged, in particular encapsulated by foaming, inside the transmission body.

If the tensioner bears linearly or extensively against an outer surface of the transmission body at least in the functional position, the tensioner can be easily arranged in the recess and easily exchanged for maintenance purposes. If the tensioner is at least partially arranged, in particular encapsulated by foaming, inside the transmission body, the tensioner is captively fixed to the transmission body with pre-mounting.

The cushion body and the transmission body may in principle comprise two separate or separable components. The seat device can thus have a straightforward and compact design if the cushion body and the transmission body comprise a common, one-piece component, in particular a foam.

In such cases, the transmission body comprises a portion of the cushion body that projects with respect to the cushion body.

As an alternative to this, if the cushion body and the transmission body are in the form of separate or separable components, it has proven to be advantageous if the transmission body has a variable surface and/or in particular comprises a flexible and/or elastic casing and a fluid, such as gas or liquid, arranged in the casing.

If the transmission body has a variable surface, the transmission body can adapt depending on the tension of the tensioner, as a result of which it is ensured that the tensioner always extensively or linearly bears against the transmission body. This reduces wear of the transmission body and/or tensioner.

In order to ensure that the cushion body automatically returns to its undeflected position as soon as the tensioner is transferred to the non-tensioned basic position, it has proven to be advantageous if the setting unit comprises at least one restoring device, which makes it possible to tension the cushion body into the basic position.

In such cases, the restoring device counteracts the tensioner and can be displaced or compressed by the tensioner in order to adjust the height and tilt of the transmission body or the cushion body.

In one embodiment, the seat device comprises a seat cover, which circumferentially surrounds the at least one cushion body and/or, at least partially, the at least one rigid seat shell. The seat cover may have an elastic design and form the restoring device.

In embodiments of the seat device, multiple cushion bodies and multiple seat shells may be provided. In one embodiment of the seat device, the seat device comprises a cushion body, at least two transmission bodies arranged or formed on the cushion body at a spacing from one another on that side of the cushion body that faces away from the seat surface, at least two substantially rigid seat shells each comprising a recess in which a respective transmission body can be arranged, and at least one setting unit comprising two tensioner, a respective one of which is arranged in a recess in one of the seat shells.

This makes it possible to set a tilt of the seat surface by deflecting the respective two tensioner differently. In such cases, a first tensioner is not tensioned or is only slightly tensioned and a different tension is applied to the second tensioner. Consequently, the transmission bodies differ in terms of their depth of penetration into the recess. As a result, an angle of the seat surface with respect to the basic position is formed.

Further features, details and advantages of the invention emerge from the appended patent claims, from the illustration of the drawing and the subsequent description of a preferred embodiment of the vehicle.

### BRIEF DESCRIPTION OF THE DRAWINGS

FIG. 1 is a sectional front view of an exemplary embodiment of the seat device in the relaxed basic position;

FIG. 2 is a sectional front view of the exemplary embodiment according to FIG. 1 in a tensioned functional position;

FIG. 3 is a sectional side view of the exemplary embodiment according to FIG. 1.

### DETAILED DESCRIPTION OF THE DRAWINGS

The figures show a seat device, provided with the reference sign 2 overall, for a vehicle, in particular a tilting vehicle (not explicitly illustrated in the figures). The seat device 2 comprises a cushion body 4, which forms a seat surface 6 on a side facing toward a user of the vehicle. Transmission bodies 8 are arranged on the cushion body 4 on the side facing away from the seat surface 6. They project in the opposite direction from the seat surface 6. In the exemplary embodiment shown in the figures, the cushion body 4 and the transmission body 8 form a common, one-piece component, in particular a foam component.

Furthermore, in the exemplary embodiment shown in the figures the seat device 2 comprises at least two substantially rigid seat shells 10, which are arranged on that side of the cushion body 4 that faces away from the seat surface 6. The seat shells 10 are fixed to a carrier structure of the vehicle. The seat shells 10 each comprise a recess 12, in which at least one transmission body 8 can be at least partially arranged.

Furthermore, the seat device 2 comprises a setting unit 14, which in the exemplary embodiment shown in the figures comprises two tensioner 16, of which a respective tensioner 16 is arranged in a recess 12 in a seat shell 10 between the cushion body 4 and the seat shell 10. The setting unit 14 of the seat device 2 also comprises a setting device 18, which is formed by a drum body 20 in the exemplary embodiment shown in the figures.

In the exemplary embodiment shown in the figures, the tensioner 16 is flexibly bendable transversely to its direction of extent and has an extensive form.

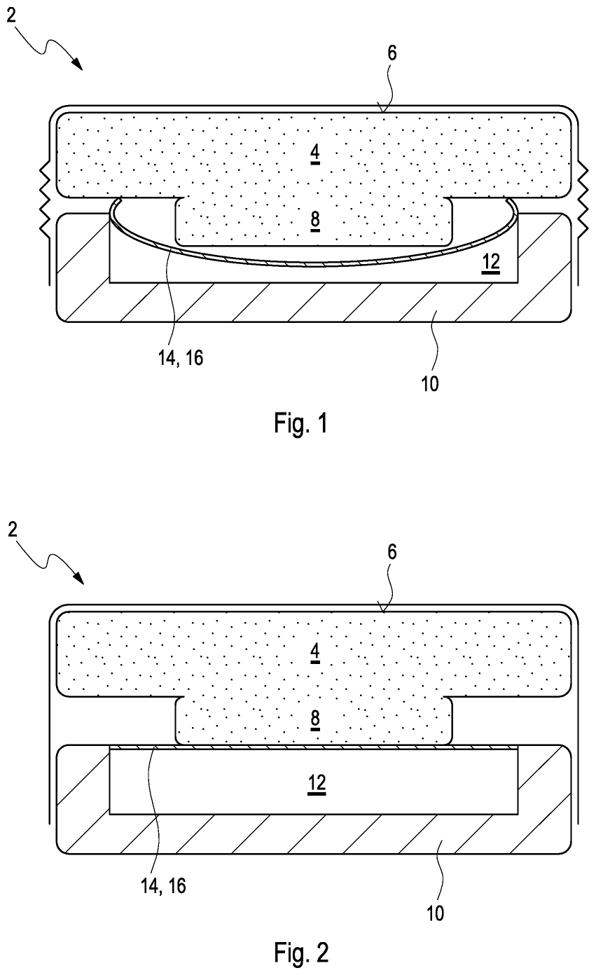

In the non-tensioned basic position (FIG. 1), the tensioner 16 sags in such cases. As a result of this, a depth of penetration of the transmission body 8 into the recess 12 in the seat shell 10 in the basic position of the tensioner 16 is at its greatest and the force made to act on the transmission body 8 by the tensioner 16 is at its lowest.

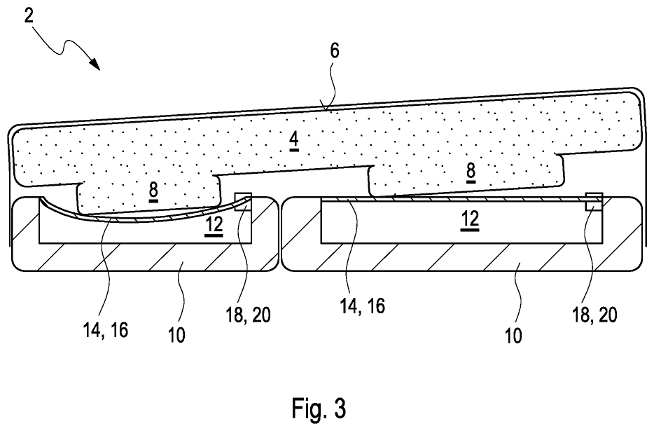

In a tensioned functional position (FIGS. 2 and 3), the depth of penetration of the transmission body 8 into the recess 12 in the seat shell 10 is reduced with respect to the basic position and the tensioning force of the tensioner 16, when the tensioner 16 acts on the transmission body 8, is increased with respect to the basic position.

A free end of the tensioner 16 is fixed to the rigid seat shell 10 and the end of the tensioner that is situated opposite the free end is fixed to the setting device 18 of the setting unit 14.

The features of the invention that are disclosed in the above description, in the claims and in the drawing may be essential, both individually and in any desired combination, for the implementation of the invention in its various embodiments.

### LIST OF REFERENCE SIGNS

2 Seat device
4 Cushion body
6 Seat surface
8 Transmission body
10 Seat shell
12 Recess
14 Setting unit
16 Tensioner
18 Setting device
20 Drum body

The invention claimed is:

1.-10. (canceled)

11. A seat device for a vehicle, comprising:
at least one cushion body which forms a seat surface on a side facing toward a user of the vehicle;
at least one transmission body which is arranged or formed on the cushion body on a side of the cushion body facing away from the seat surface and which extends away from the cushion body;
at least one substantially rigid seat shell which is arranged on a side of the cushion body that faces away from the seat surface and is directly or indirectly fixable to a carrier structure of the vehicle, wherein the rigid seat shell comprises at least one recess in which at least the transmission body is at least partially arrangeable, and
at least one setting unit which is arranged between the cushion body and the seat shell and comprises at least one tensioner,
wherein the tensioner is arranged in the recess in the seat shell between the cushion body and the seat shell and is transferrable from a relaxed basic position, in which a depth of penetration of the transmission body into the recess in the seat shell is greatest, to at least one tensioned functional position, in which the transmission body is displaced by the tensioner into a position in which the depth of penetration of the transmission body into the recess in the seat shell is reduced with respect to the basic position.

12. The seat device according to claim 11, wherein
a free end of the tensioner is directly or indirectly fixed in or to the seat shell, and/or
the setting unit comprises at least one setting device, to which an end of the tensioner that is situated opposite the free end is fixed, the setting device being configured to move the tensioner for transferring from the basic position to the functional position.

13. The seat device according to claim 11, wherein
the tensioner is flexibly bendable transversely to its direction of extent, and/or
the tensioner has an extensive form comprising a blind-shaped or mat-shaped form, or the tensioner has a linear form comprising a band-like, cable-like or wire-like tensioner.

14. The seat device according to claim 11, wherein
the tensioner is elastically extensible along its direction of extent and/or the tensioner has an extensive or linear form.

15. The seat device according to claim 13, wherein
the setting device of the setting unit comprises a drum body, which is drivable in rotation and onto which the tensioner can be wound up when it is transferred from the basic position to the functional position.

16. The seat device according to claim 11, wherein
the tensioner bears linearly or extensively against an outer surface of the transmission body at least in the functional position or the tensioner is at least partially arranged inside the transmission body.

17. The seat device according to claim 11, wherein
the cushion body and the transmission body comprise a common, one-piece component.

18. The seat device according to claim 11, wherein
the transmission body has a variable surface and/or comprises a flexible and/or elastic casing and a fluid arranged in the casing.

19. The seat device according to claim 11, wherein
the setting unit comprises at least one restoring device which restores the cushion body into the basic position.

20. The seat device according to claim 11, further comprising:
at least two transmission bodies arranged or formed on the cushion body at a spacing from one another on that side of the cushion body that faces away from the seat surface;
at least two substantially rigid seat shells, each comprising a recess in which a respective transmission body is arrangeable; and
two tensioners, a respective one of which is arranged in a recess in one of the seat shells.

21. The seat device according to claim 11, wherein the seat device is a tilting vehicle seat device.
